(19) United States
(12) Patent Application Publication
(10) Pub. No.: US 2022/0091360 A1
(43) Pub. Date: Mar. 24, 2022

(54) LENS DRIVING DEVICE, CAMERA MODULE, AND CAMERA MOUNTING DEVICE

(71) Applicants: Tomohiko OSAKA, Tokyo (JP); Shigeki EDAMATSU, Tokyo (JP); MITSUMI ELECTRIC CO., LTD., Tokyo (JP)

(72) Inventors: Tomohiko OSAKA, Tokyo (JP); Shigeki EDAMATSU, Tokyo (JP)

(73) Assignee: MITSUMI ELECTRIC CO., LTD., Tokyo (JP)

(21) Appl. No.: 17/423,975

(22) PCT Filed: Dec. 19, 2019
(86) PCT No.: PCT/JP2019/049793

§ 371 Date: Jul. 19, 2021

(30) Foreign Application Priority Data
Jan. 21, 2019 (JP) 2019-007607

(51) Int. Cl. G02B 7/09; G02B 27/64; G03B 5/00; G03B 13/36; H04N 5/225; H04N 5/232

(52) U.S. Cl. CPC G02B 7/09; G02B 27/646; G03B 5/00; G03B 13/36; H02K 41/0354; H04N 5/23287; G03B 2205/0007; G03B 2205/0069; H04N 5/2254

(57) ABSTRACT

A lens driving device includes a first holder configured to hold a lens section, a second holder provided around a lens holder, a support member that elastically supports the first holder with respect to the second holder, and an actuator that includes a coil with a winding so arranged on the first holder as to surround the lens section, and a magnet so provided on the second holder as to face the coil, and is configured to move the first holder with respect to the second holder in a direction of an optical axis. An end portion of the winding is provided with an upright terminal that is set upright with respect to a winding plane of the winding and electrically connected to the support member with a fixing material. The first holder includes a terminal positioning part that internally accepts the upright terminal.

### TECHNICAL FIELD

The present invention relates to a lens driving device, a camera module, and a camera-loaded apparatus.

### BACKGROUND ART

Various lens driving devices each having an autofocus function (hereinafter referred to as “AF function,” AF: Auto Focus) to automatically perform focusing during the imaging of a subject have already been proposed.

For instance, Patent Literature 1 discloses a lens driving device including an AF movable part that holds a lens section, an AF immovable part so provided as to surround the AF movable part, and an AF drive unit that moves the AF movable part with respect to the AF immovable part in the direction of an optical axis during the focusing.

The AF drive unit includes an AF coil part so provided on the AF movable part as to surround the lens section, and an AF magnet part so provided on the AF immovable part as to face the AF coil part.

The AF coil part is an air core coil to be electrified during the focusing and is wound on an outer peripheral face of the AF movable part. Both end portions of the AF coil part are tied to tying parts of the AF movable part.

### CITATION LIST PATENT LITERATURE

PTL 1: WO 2016/6168

### SUMMARY OF THE INVENTION PROBLEMS TO BE SOLVED BY THE INVENTION

The lens driving device of Patent Literature 1 as above requires to tie the end portions of the AF coil part to the tying parts during the attachment of the AF coil part to the AF movable part, which may decrease the efficiency of assembly.

An object of the present invention is to provide a lens driving device, a camera module, and a camera-loaded apparatus, all allowing an efficient assembly.

### Means for Solving the Problem

In one mode, a lens driving device according to the present invention includes a first holder configured to hold a lens section, a second holder provided around a lens holder, a support member that elastically supports the first holder with respect to the second holder, and an actuator that includes a coil with a winding so arranged on the first holder as to surround the lens section, and a magnet so provided on the second holder as to face the coil, and is configured to move the first holder with respect to the second holder in a direction of an optical axis. An end portion of the winding is provided with an upright terminal that is set upright with respect to a winding plane of the winding and electrically connected to the support member with a fixing material, and the first holder includes a terminal positioning part that internally accepts the upright terminal.

In one mode, a camera module according to the present invention includes the lens driving device as above, a lens section to be fitted to the first holder, and an imaging unit configured to capture a subject image formed by the lens section.

In one mode, a camera-loaded apparatus according to the present invention is a camera-loaded apparatus as information equipment or transportation equipment and includes the camera module as above and an image processor configured to process image information obtained by the camera module.

### Effect of the Invention

According to the present invention, a lens driving device, a camera module, and a camera-loaded apparatus, all allowing an efficient assembly, are provided.

### BRIEF DESCRIPTION OF THE DRAWINGS

FIG. 1A is a front view of a smartphone loaded with a camera module according to an embodiment of the present invention.

FIG. 1B is a rear view of the smartphone loaded with the camera module according to an embodiment of the present invention.

FIG. 2 is a perspective view illustrating an appearance of the camera module.

FIG. 3 is an exploded perspective view of the camera module.

FIG. 4 is an exploded perspective view of the camera module as viewed from an angle different from the angle in FIG. 3.

FIG. 5 is an exploded perspective view of a lens driving device.

FIG. 6 is an exploded perspective view of the lens driving device as viewed from an angle different from the angle in FIG. 5.

FIG. 7 is a side view of a lens holder and an AF coil part.

FIG. 8A is a perspective view of the lens holder and the AF coil part.

FIG. 8B is an exploded perspective view of the lens holder and the AF coil p art.

FIG. 9A is a perspective view of an upper elastic support member.

FIG. 9B is a perspective view of a lower elastic support member.

FIG. 10A is a perspective view of a magnet holder.

FIG. 10B is a perspective view of the magnet holder as viewed from an angle different from the angle in FIG. 10A.

FIG. 11 is a perspective view for explaining a method for fabricating an AF coil part.

FIG. 12 is a perspective view for explaining the method for fabricating an AF coil part.

FIG. 13 is a perspective view of an AF coil part and a jig both according to Modification 1.

FIG. 14 is a flowchart for explaining the method for fabricating an AF coil p art.

FIG. 15A is a front view of an automobile as a camera-loaded apparatus that is loaded with an onboard camera module.

FIG. 15B is a perspective view of the automobile as a camera-loaded apparatus, which is loaded with the onboard camera module.

### MODE FOR CARRYING OUT THE INVENTION

In the following, an embodiment of the present invention is described in detail based on the accompanying drawings.

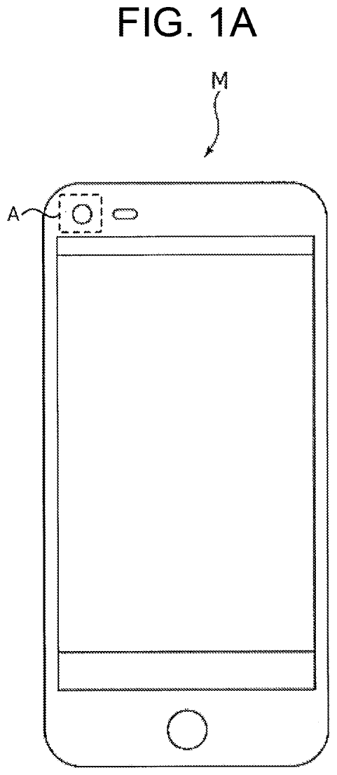

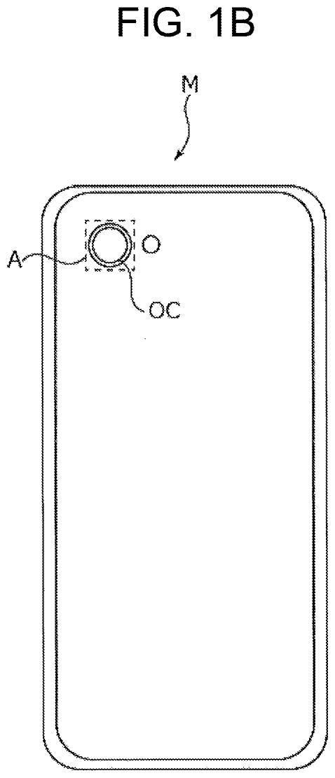

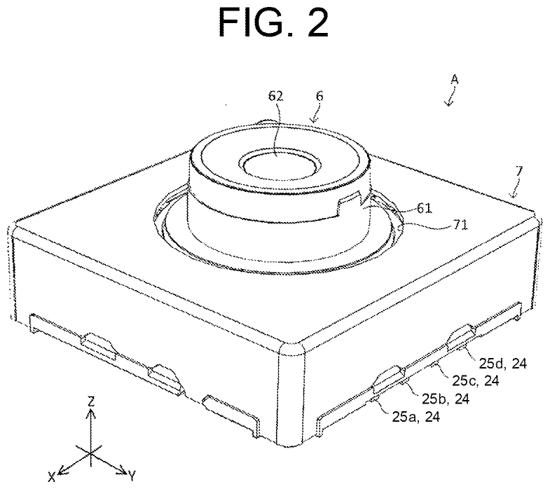

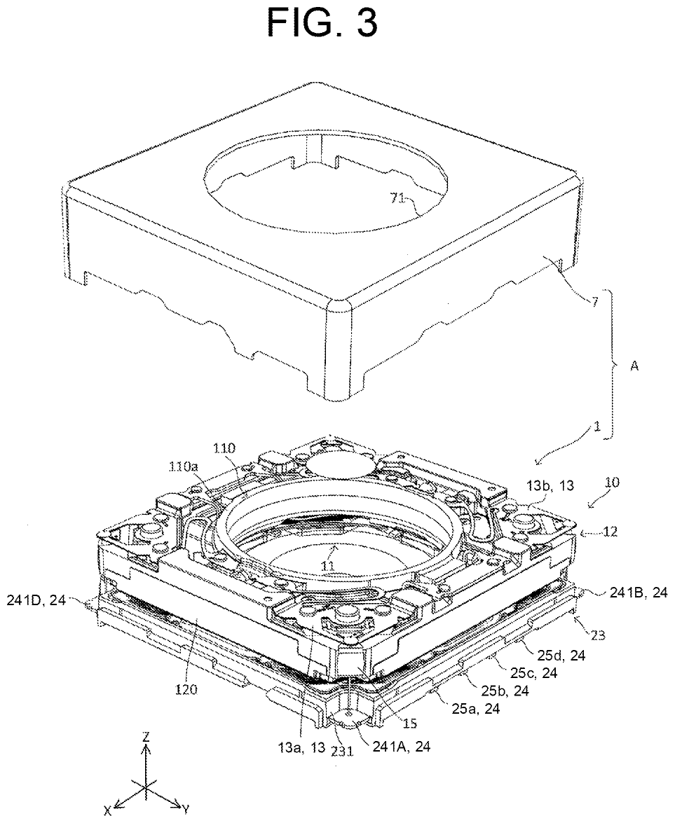

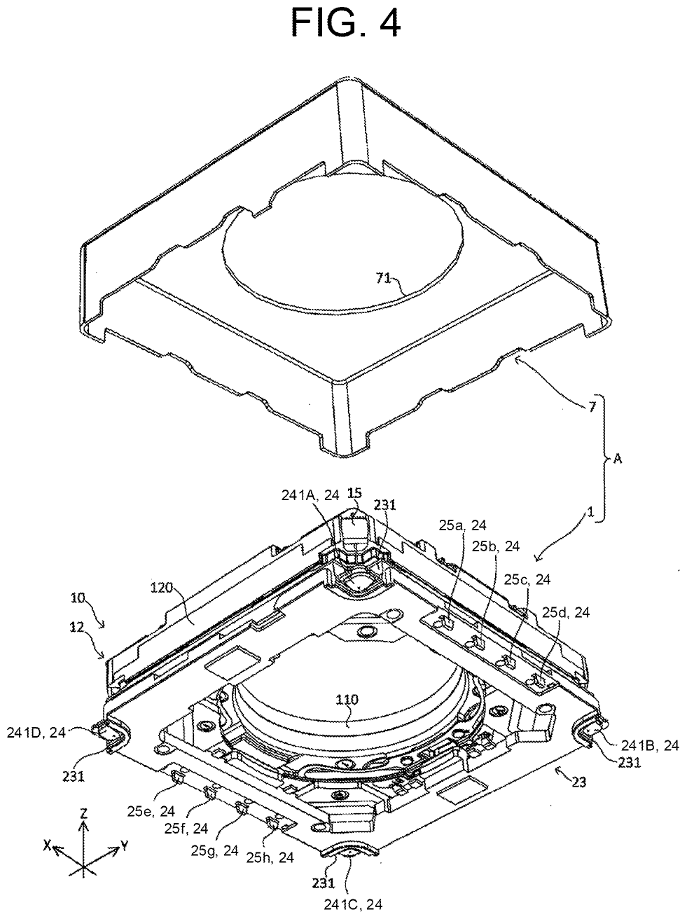

FIGS. 1A and 1B are diagrams illustrating a smartphone M loaded with a camera module A according to an embodiment of the present invention. FIG. 2 is a perspective view illustrating an appearance of the camera module A. FIGS. 3 and 4 are exploded perspective views of the camera module A.

In the present embodiment, an orthogonal coordinate system (X, Y, Z) is used to make a description, as illustrated in FIGS. 2 through 4. An orthogonal coordinate system (X, Y, Z) in each figure referred to later is the same as the orthogonal coordinate system (X, Y, Z) in each of FIGS. 2 through 4.

The camera module A is loaded so that the X direction may coincide with a top and bottom direction (or a right and left direction), the Y direction may coincide with the right and left direction (or the top and bottom direction), and the Z direction may coincide with a front and rear direction when imaging is actually performed with the smartphone M.

In other words, the Z direction coincides with an optical axis direction, so that the plus side in the Z direction (upper side of FIG. 2, for instance) is a light reception side in the optical axis direction (also referred to as a macro position side) and the minus side in the Z direction (lower side of FIG. 2, for instance) is an image formation side in the optical axis direction (also referred to as an infinity position side). The X direction and the Y direction, both orthogonal to the z-axis, are each referred to as “direction orthogonal to the optical axis” and an XY plane is referred to as “plane orthogonal to the optical axis.”

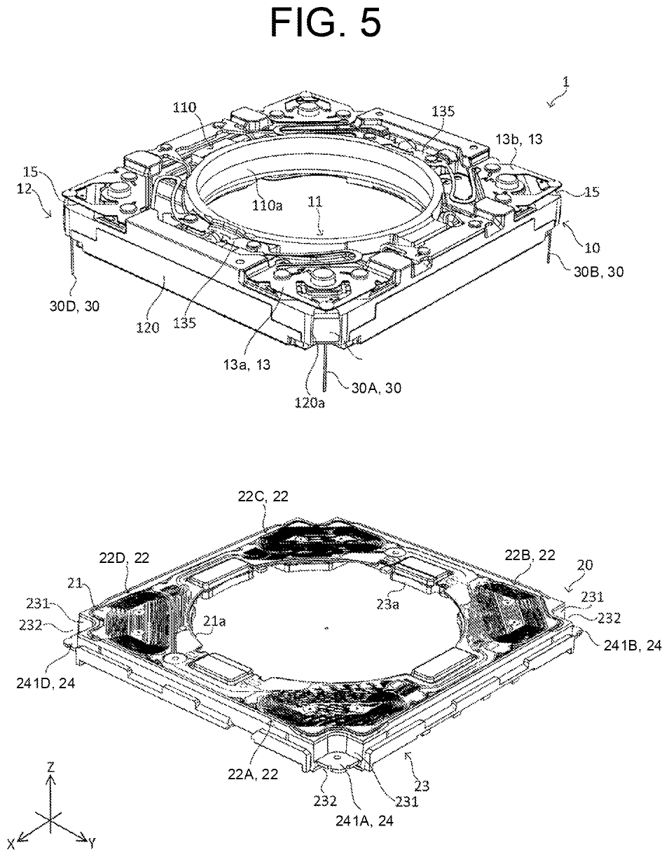

In the description made below on individual members constituting the camera module A, the terms “radial direction” and “circumferential direction” mean such directions of an OIS movable part 10 (to be specific, a lens holder 110 and a magnet holder 120, see FIG. 5) to be described later, respectively, unless otherwise specified.

For convenience of description, in a plan view shape of the camera module A illustrated in FIG. 2 and the individual members constituting the camera module A as viewed in the Z direction, a corner located on the plus side in the X direction and, at the same time, on the plus side in the Y direction is referred to as a first corner, a corner located on the minus side in the X direction and, at the same time, on the plus side in the Y direction is referred to as a second corner, a corner located on the minus side in the X direction and, at the same time, on the minus side in the Y direction is referred to as a third corner, and a corner located on the plus side in the X direction and, at the same time, on the minus side in the Y direction is referred to as a fourth corner.

The smartphone M illustrated in FIGS. 1A and 1B is loaded with the camera module A as a rear camera OC, for instance. To the camera module A, a lens driving device 1 having an autofocus function (hereinafter referred to as “AF function,” AF: Auto Focus) to automatically perform focusing during the imaging of a subject and a shake correction function (hereinafter referred to as “OIS function,” OIS: Optical Image Stabilization) to optically correct camera shake (vibration) occurring upon imaging so as to reduce irregularities of an image is applied.

The lens driving device 1, which is useful for autofocus and for shake correction, includes an autofocus drive unit (hereinafter referred to as “AF drive unit”) for moving a lens section in the optical axis direction and a shake correction drive unit (hereinafter referred to as “OIS drive unit”) for swaying the lens section in a plane orthogonal to the optical axis.

<Camera Module>

As an example, the camera module A includes a cover 7, a lens section 6 with a lens 62 contained in a lens barrel 61 in a cylindrical shape, an imaging unit (not illustrated) that captures a subject image formed by the lens section 6, and the lens driving device 1 for autofocus and shake correction, as illustrated in FIGS. 2 and 3.

<Cover>

The cover 7 is in the form of a capped quadrangular tube that is square in plan view shape as viewed in the Z direction (optical axis direction). The cover 7 has a circular opening 71 in a top face (face on the plus side in the Z direction). The lens section 6 fronts the outside through the opening 71. The cover 7 is fixed to a base 23 with an adhesive (not illustrated), for instance.

<Imaging Unit>

The imaging unit (not illustrated) is arranged on the minus side in the Z direction (image formation side in the optical axis direction) of the lens driving device 1. The imaging unit includes an imaging element (not illustrated), such as an image sensor of a CCD (charge-coupled device) type and an image sensor of a CMOS (complementary metal oxide semiconductor) type, and a sensor substrate on which the imaging element is mounted. The imaging element captures a subject image formed by a lens section (not illustrated). The lens driving device 1 is installed on the sensor substrate (not illustrated) and electrically connected to the sensor substrate.

<Lens Driving Device>

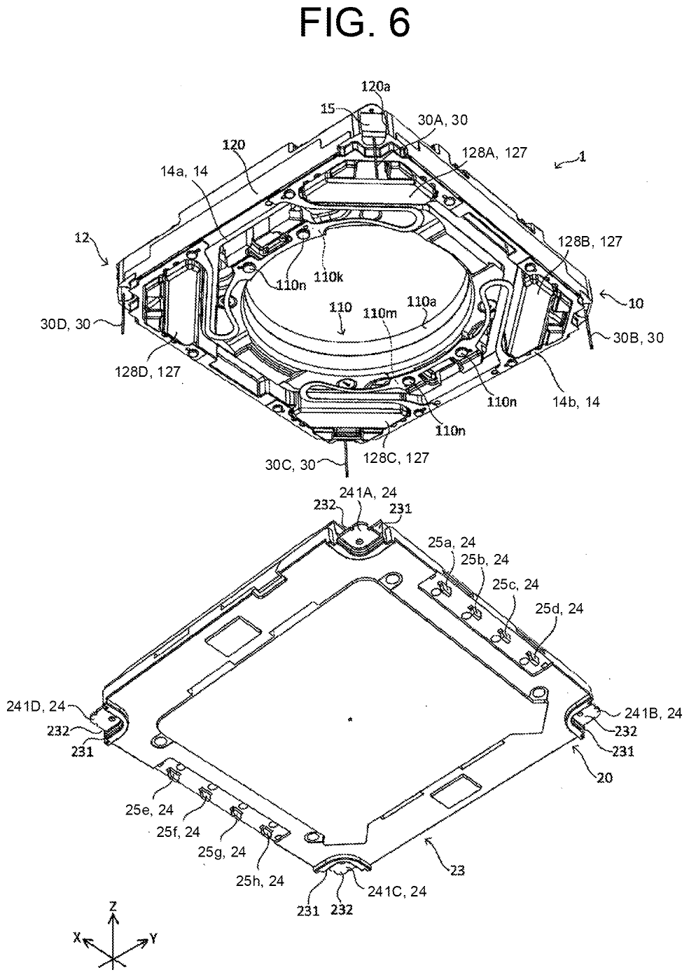

FIGS. 5 and 6 are exploded perspective views of the lens driving device 1 (see FIG. 3). As illustrated in FIGS. 5 and 6, the lens driving device 1 includes the OIS movable part 10 (also referred to simply as the movable part), an OIS immovable part 20 (also referred to simply as an immovable part), and suspension wires 30 (30A through 30D).

<OIS Movable Part>

The OIS movable part 10 includes an OIS magnet part constituting an OIS voice coil motor. The OIS movable part 10 is swayed in a plane orthogonal to the optical axis during the shake correction. The OIS immovable part 20 to be described later includes an OIS coil part. In other words, a moving magnet system is applied to the OIS drive unit of the lens driving device 1. In addition, the OIS movable part 10 is an AF unit including the AF drive unit. In other words, the AF drive unit is constituted of constituent members of the OIS movable part 10.

The OIS movable part 10 is arranged separately from the OIS immovable part 20 on the plus side in the Z direction (light reception side in the optical axis direction). The OIS movable part 10 is coupled to the OIS immovable part 20 by the suspension wires 30 (30A through 30D).

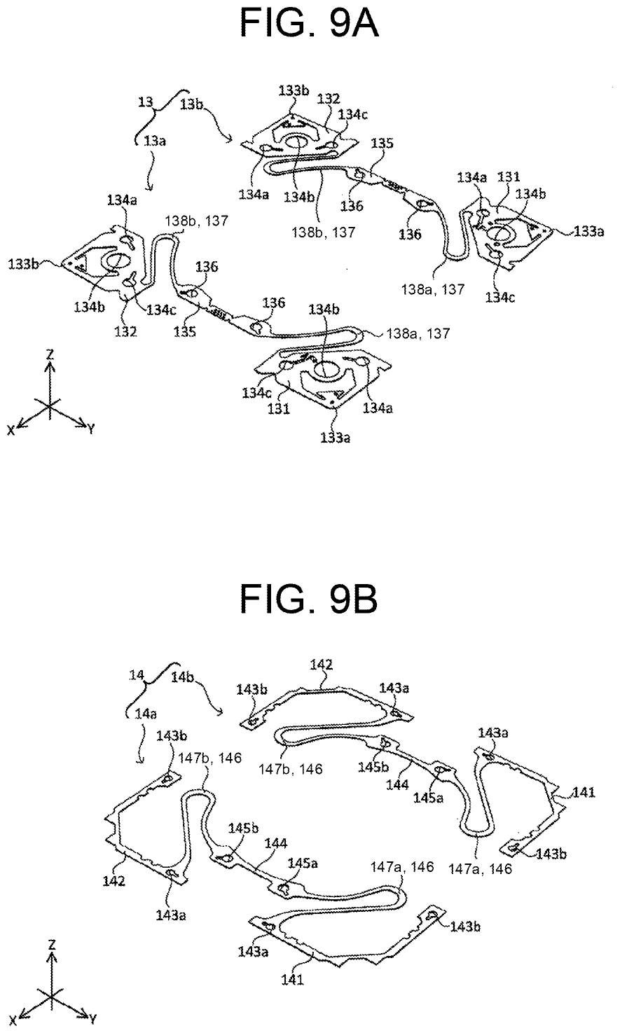

Specifically, first end portions (lower end portions) of the suspension wires 30 (30A through 30D) are fixed to the OIS immovable part 20 (to be more specific, wire connectors 241A through 241D of a lead 24). Second end portions (upper end portions) of the suspension wires 30 (30A through 30D) are fixed to the OIS movable part 10 (to be more specific, an upper elastic support member 13, see FIG. 9A). The OIS movable part 10 is so supported by the suspension wires 30 (30A through 30D) as to be swayable in a plane orthogonal to the optical axis.

As an example, out of the four suspension wires 30 (30A through 30D), the suspension wire 30A arranged at the first corner and the suspension wire 30B arranged at the second corner constitute a power feeding path to an AF controller (not illustrated).

Also as an example, the suspension wire 30C arranged at the third corner and the suspension wire 30D arranged at the fourth corner constitute a signal path for transmitting a control signal to the AF controller (not illustrated). The number of the suspension wires 30 is not limited to the above number but may be larger than four.

Referring to FIGS. 5 through 10B, the OIS movable part 10 is described. As illustrated in FIGS. 5 and 6, the OIS movable part 10 includes an AF movable part 11, an AF immovable part 12, the upper elastic support member 13, and a lower elastic support member 14.

<AF Movable Part>

The AF movable part 11 is arranged separately from the AF immovable part 12 inside in the radial direction. The AF movable part 11 is coupled to the AF immovable part 12 by the upper elastic support member 13 and the lower elastic support member 14.

The AF movable part 11 includes the lens holder 110 and an AF coil part 111 constituting an AF voice coil motor (see FIGS. 5 through 8B).

The AF movable part 11 as such is moved with respect to the AF immovable part 12 in the optical axis direction (Z direction) during the focusing. The AF immovable part 12 holds a magnet part 127 constituting an AF voice coil motor. In other words, the AF drive unit of the lens driving device 1 is a drive unit on a moving coil system.

<Lens Holder>

Referring to FIGS. 5 through 8B, the lens holder 110 is described. The lens holder 110 includes a lens container 110a in a tubular form. An inner peripheral face of the lens container 110a is preferably provided with a groove (not illustrated) to which an adhesive is applied.

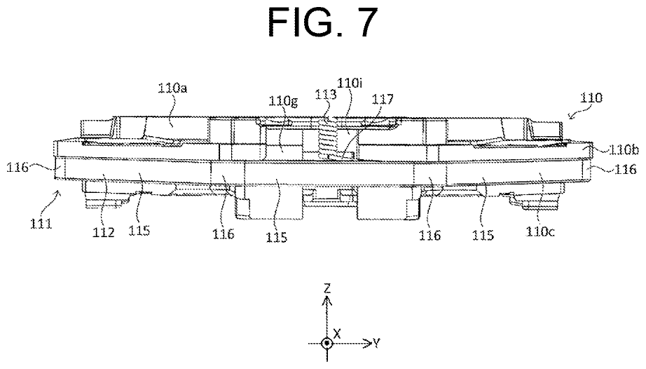

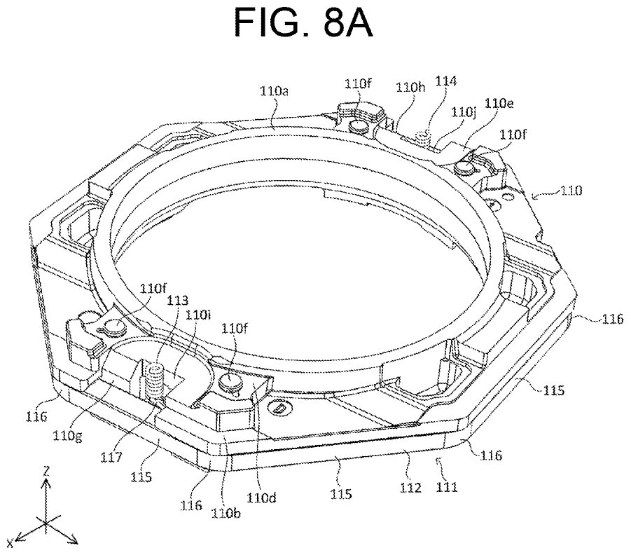

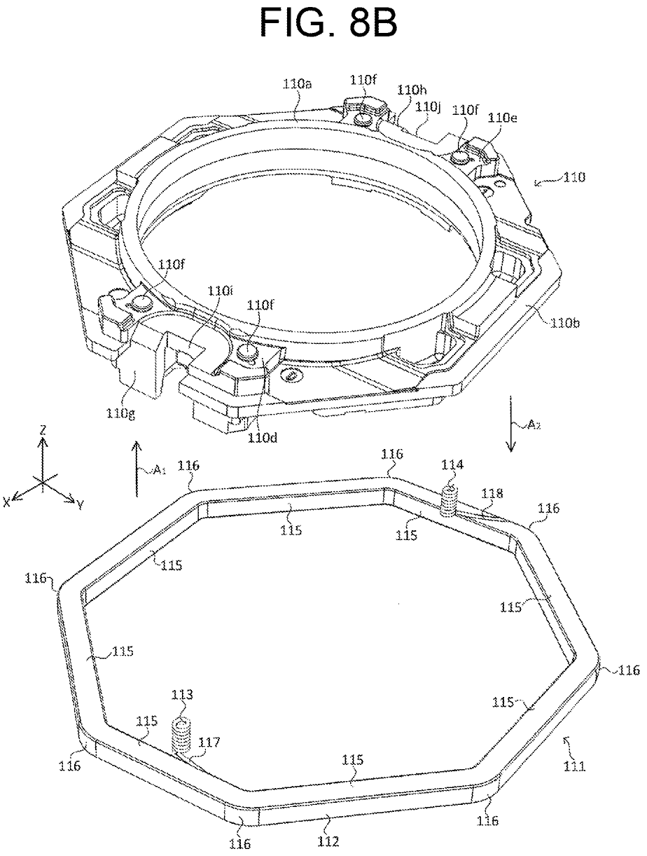

The lens holder 110 includes a flange 110b (see FIGS. 7 and 8B) protruding from an outer peripheral face of the lens container 110a outward in the radial direction. The flange 110b is approximately octagonal in plan view shape. The lens holder 110 includes a coil positioning part 110c (see FIG. 7) continuing over the entire circumference on one side (the minus side in the Z direction) of the flange 110b on the outer peripheral face.

The lens holder 110 includes upper spring fixing parts 110d and 110e on a face (top face) on the plus side in the Z direction. The upper spring fixing part 110d is provided in an end portion on the plus side in the X direction of the top face of the lens holder 110. The upper spring fixing part 110e is provided in an end portion on the minus side in the X direction of the top face of the lens holder 110.

The upper spring fixing parts 110d and 110e each have a pair of upper bosses 110f. The pairs of upper bosses 110f locate and fix inner fixation parts 135 of upper spring elements 13a and 13b (see FIGS. 5 and 9A) to be described later, respectively. The shape and number of upper bosses are not limited to those of the upper bosses 110f of the present embodiment.

The lens holder 110 has a pair of outer notches 110g and 110h and a pair of inner notches 110i and 110j.

The outer notch 110g is provided in an end portion on the plus side in the X direction of the flange 110b. The inner notch 110i is provided in the outer peripheral face of the lens container 110a, which face includes a bottom face of the outer notch 110g. The inner notch 110i has a width narrower than the width of the outer notch 110g.

The outer notch 110h is provided in an end portion on the minus side in the X direction of the flange 110b. The inner notch 110j is provided in the outer peripheral face of the lens container 110a, which face includes a bottom face of the outer notch 110h. The inner notch 110j has a width narrower than the width of the outer notch 110h. The inner notch 110i and the inner notch 110j apply to an example of a first terminal positioning part and an example of a second terminal positioning part, respectively.

The inner notches 110i and 110j are each open at both ends in the Z direction. As illustrated in FIG. 8A, a first terminal 113 of the AF coil part 111 is arranged in the inner notch 110i. The first terminal 113 is inserted into the inner notch 110i through an opening (also referred to as a first opening) on the minus side in the Z direction of the inner notch 110i in an attachment operation.

In the inner notch 110j, a second terminal 114 of the AF coil part 111 is arranged, as illustrated in FIG. 8A. The second terminal 114 is inserted into the inner notch 110j through an opening (also referred to as a first opening) on the minus side in the Z direction of the inner notch 110j in an attachment operation.

The lens holder 110 includes lower spring fixing parts 110k and 110m (see FIG. 6) on a face (bottom face) on the minus side in the Z direction. The lower spring fixing part 110k is provided in an end portion on the plus side in the X direction of the bottom face of the lens holder 110. The lower spring fixing part 110m is provided in an end portion on the minus side in the X direction of the bottom face of the lens holder 110.

As illustrated in FIG. 6, the lower spring fixing parts 110k and 110m each have lower bosses 110n that locate and fix an inner fixation part 144 of a lower spring element 14a or 14b to be described later.

In the present embodiment, the lens holder 110 is formed of a molding material composed of polyarylate (PAR) or a PAR alloy (e.g., PAR/PC) obtained by blending two or more resin materials including PAR. As a result, the weld strength is increased as compared with a conventional molding material such as a liquid crystal polymer (LCP: Liquid Crystal Polymer), so that the toughness and the impact resistance are ensured even if the lens holder 110 is made thinner. Consequently, it is possible to reduce the dimensions of the lens driving device 1 and achieve miniaturization and weight saving.

<AF Coil Part>

Referring to FIGS. 7 through 8B, the AF coil part 111 is described. The AF coil part 111 is an air core coil to be electrified during the focusing. The AF coil part 111 as attached is wound on an outer peripheral face of the coil positioning part 110c of the lens holder 110.

The AF coil part 111 is constituted of a wire such as a copper wire, for instance. The AF coil part 111 includes a winding 112, the first terminal 113, and the second terminal 114.

The winding 112 is constituted of a wire wound in a polygonal shape (regular octagonal shape in the present embodiment). The winding 112 has two or more (eight in the present embodiment) side portions 115 and two or more (eight in the present embodiment) vertex portions 116 joining the side portions 115 adjacent to each other.

The winding 112 has a first end portion 117 as one end portion and a second end portion 118 as the other end portion. The first end portion 117 and the second end portion 118 are each provided on one of the side portions 115. The side portion 115, on which the first end portion 117 is provided, is located opposite to the side portion 115, on which the second end portion 118 is provided.

The first end portion 117 of the winding 112 is provided with the first terminal 113. The first terminal 113 is upright with respect to a turning plane of the winding 112. Specifically, the first terminal 113 extends from the winding 112 in a normal direction of the turning plane of the winding 112 (that is to say, in the direction of a turning axis of the winding 112). The first terminal 113 applies to an example of an upright terminal.

It may be assumed that the first terminal 113 extends from the winding 112 in an attachment direction where the AF coil part 111 is attached to the lens holder 110.

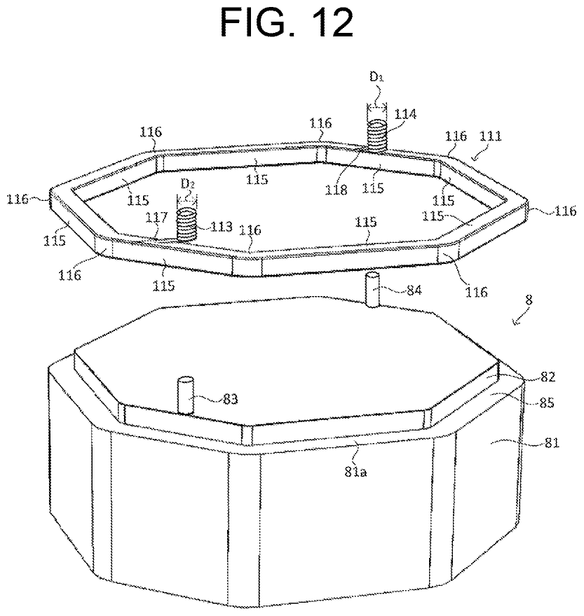

The first terminal 113 is in the form of a coil unchanged in outer diameter. An outer diameter D2 (see FIG. 12) of the first terminal 113 is preferably two or more times as large as the outer diameter of the wire constituting the winding 112.

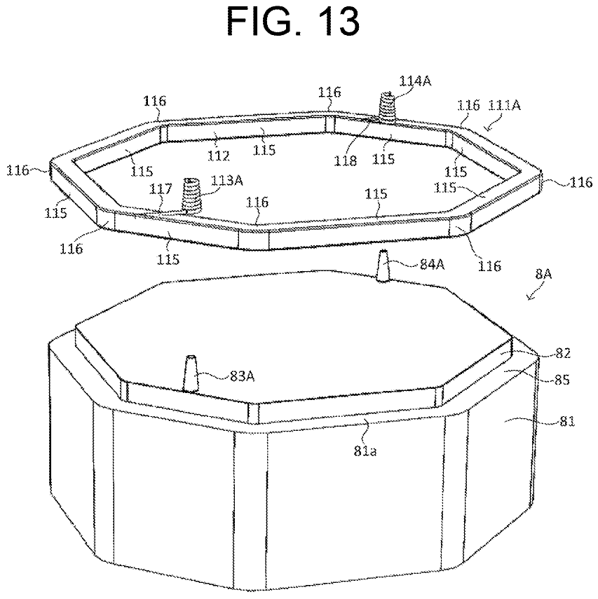

An AF coil part 111A illustrated in FIG. 13 is an AF coil part in Modification 1. The first terminal of the AF coil part may have an outer diameter sequentially reduced from a base end toward a tip end, as is the case with a first terminal 113A of the AF coil part 111A.

The second end portion 118 of the winding 112 is provided with the second terminal 114. The second terminal 114 is upright with respect to the turning plane of the winding 112. Specifically, the second terminal 114 extends from the winding 112 in the normal direction of the turning plane of the winding 112 (that is to say, in the direction of the turning axis of the winding 112). The second terminal 114 applies to an example of the upright terminal.

It may be assumed that the second terminal 114 extends from the winding 112 in the attachment direction where the AF coil part 111 is attached to the lens holder 110.

The second terminal 114 is in the form of a coil unchanged in outer diameter. An outer diameter D1 of the second terminal 114 is preferably two or more times as large as the outer diameter of the wire constituting the winding 112.

The second terminal of the AF coil part may have an outer diameter sequentially reduced from a base end toward a tip end, as is the case with a second terminal 114A of the AF coil part 111A illustrated in FIG. 13.

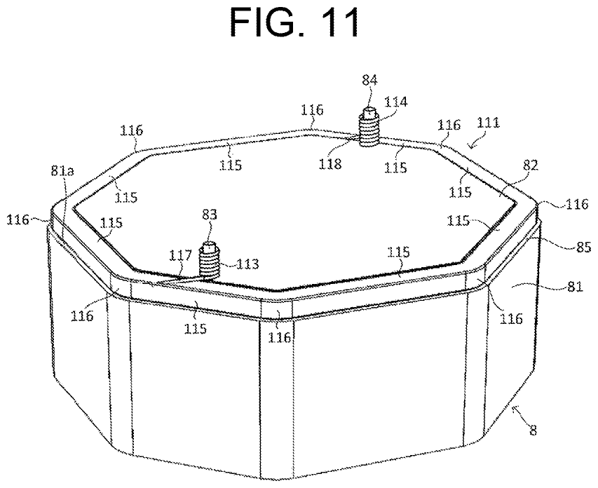

Next, a method for fabricating the AF coil part 111 is explained with reference to FIGS. 11 through 14.

<Jig>

In the method for fabricating the AF coil part 111, a jig 8 illustrated in FIGS. 11 and 12 is used. The jig 8 has a base 81, a winding part 82, a first protrusion 83, and a second protrusion 84.

The base 81 is in the form of a solid or hollow column. An outer peripheral face of the base 81 assumes a polygonal contour (regular octagonal contour in the present embodiment). The outer peripheral face of the base 81 is not particularly limited in contour.

The winding part 82 is provided on a first end face 81a out of both end faces in the axial direction of the base 81. An outer peripheral face of the winding part 82 is of the same shape as the outer peripheral face of the lens container 110a. In other words, the outer peripheral face of the winding part 82 has a shape (regular octagonal shape in the present embodiment) that is along an inner peripheral face of the AF coil part 111.

The winding part 82 has an outer diameter smaller than the outer diameter of the base 81. The outer peripheral face of the winding part 82 and the outer peripheral face of the base 81 are joined together by a step portion 85.

The first protrusion 83 is provided on a first end face of the winding part 82. The first protrusion 83 is provided in a position on the first end face that is near the outer peripheral face of the winding part 82. The first protrusion 83 is in the form of a column unchanged in outer diameter.

The second protrusion 84 is provided on the first end face of the winding part 82. The second protrusion 84 is provided in a position on the first end face that is near the outer peripheral face of the winding part 82. The second protrusion 84 is provided opposite to the first protrusion 83 in a radial direction of the winding part 82. The second protrusion 84 is in the form of a column unchanged in outer diameter.

The structure of the jig is designable appropriately to the structure of the AF coil part to be fabricated. If the AF coil part includes three or more terminals, the jig may have protrusions whose number corresponds to the number of terminals of the AF coil part.

A jig 8A illustrated in FIG. 13 is a jig in Modification 1. The jig 8A has a base 81, a winding part 82, a first protrusion 83A, and a second protrusion 84A. The structure of the base 81 and the winding part 82 is the same as the jig 8 illustrated in FIGS. 11 and 12.

The first protrusion 83A is provided on a first end face of the winding part 82. The first protrusion 83A is provided in a position on the first end face that is near an outer peripheral face of the winding part 82. The first protrusion 83A is sequentially reduced in dimensions from a base end toward a tip end. In other words, the first protrusion 83A is in the shape of the truncated cone or cone, whose outer diameter is larger at the base end than at the tip end.

The second protrusion 84A is provided on the first end face of the winding part 82. The second protrusion 84A is provided in a position on the first end face that is near the outer peripheral face of the winding part 82. The second protrusion 84A is provided opposite to the first protrusion 83A in a radial direction of the winding part 82. The second protrusion 84A is sequentially reduced in dimensions from a base end toward a tip end. In other words, the second protrusion 84A is in the shape of the truncated cone or cone, whose outer diameter is larger at the base end than at the tip end.

The jig 8A illustrated in FIG. 13 is used in a method for fabricating the AF coil part 111A illustrated in FIG. 13.

<Fabrication Process of AF Coil Part>

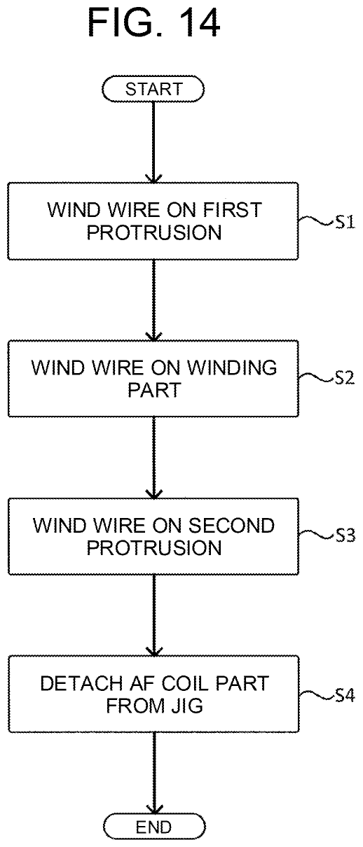

Next, a fabrication process of the AF coil part 111 is described with reference to FIGS. 11, 12, and 14. FIG. 14 is a flowchart illustrating an example of the fabrication process of the AF coil part 111. In the description below, it is assumed that the fabrication process is performed by a fabrication device (not illustrated) such as a winding robot. The fabrication process described below may also be performed by an operator.

Initially in step S1 in FIG. 14, a fabrication device such as a winding robot winds a first end portion of a wire with a specified length on an outer peripheral face of the first protrusion 83 of the jig 8. The wire is wound on the first protrusion 83 from a tip end toward a base end of the first protrusion 83. In step S1, a part corresponding to the first terminal 113 of the AF coil part 111 is formed.

Next in step S2 in FIG. 14, the fabrication device winds a middle portion of the wire on the outer peripheral face of the winding part 82. In step S2, a part corresponding to the winding 112 of the AF coil part 111 is formed.

Next in step S3 in FIG. 14, the fabrication device winds a second end portion of the wire on an outer peripheral face of the second protrusion 84 of the jig 8. The wire is wound on the second protrusion 84 from a base end toward a tip end of the second protrusion 84. In step S3, a part corresponding to the second terminal 114 of the AF coil part 111 is formed. At the end of step S3, the AF coil part 111 is completed as illustrated in FIG. 11.

Finally in step S4 in FIG. 14, the AF coil part 111 is detached from the jig 8 as illustrated in FIG. 12.

<Method for Attaching AF Coil Part>

Next, a method for attaching the AF coil part 111 to the lens holder 110 is described with reference to FIGS. 7 through 8B.

Initially, the fabrication device (not illustrated) places the AF coil part 111 and the lens holder 110 in such a positional relationship as illustrated in FIG. 8B.

In the state as above, the first terminal 113 of the AF coil part 111 and the inner notch 110i (also referred to as the first terminal positioning part) of the lens holder 110 are consistent with each other in a circumferential direction of the lens holder 110, and the second terminal 114 of the AF coil part 111 and the inner notch 110j (also referred to as the second terminal positioning part) of the lens holder 110 are consistent with each other in the circumferential direction of the lens holder 110.

Next, the fabrication device displaces the AF coil part 111 in a direction allowing approach to the lens holder 110 (direction indicated by an arrow A1 in FIG. 8B). The fabrication device may displace the lens holder 110 in a direction allowing approach to the AF coil part 111 (direction indicated by an arrow A2 in FIG. 8B).

In other words, the AF coil part 111 is attached to the coil positioning part 110c of the lens holder 110 from one side in the axial direction (the minus side in the Z direction, for instance) of the lens holder 110.

In the state of attachment, the first terminal 113 of the AF coil part 111 is positioned in the inner notch 110i of the lens holder 110. The second terminal 114 of the AF coil part 111 is positioned in the inner notch 110j of the lens holder 110.

The fabrication device fixes the first terminal 113 and the second terminal 114 as such to the upper elastic support member 13 with solder. Such attachment operation is automatically performed by the fabrication device. At least part of the attachment operation as above, however, may manually be performed by an operator.

<AF Immovable Part>

Referring to FIGS. 5, 6, 10A, and 10B, the AF immovable part 12 is described. The AF immovable part 12 includes the magnet holder 120 and the magnet part 127.

<Magnet Holder>

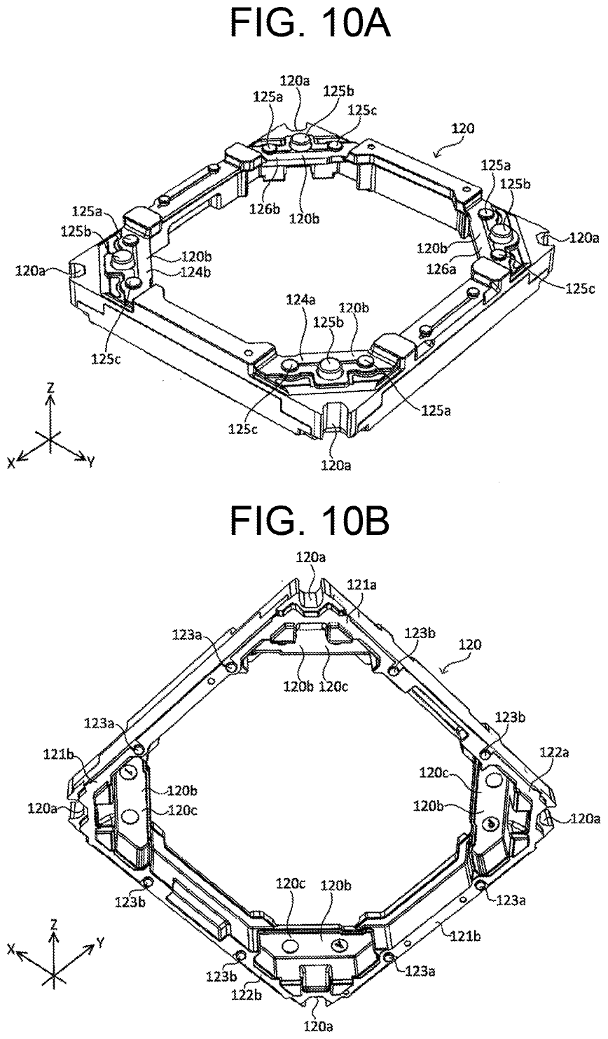

The magnet holder 120 is in the form of a quadrangular tube that is square in plan view shape as viewed in the Z direction. The magnet holder 120 has recesses 120a (see FIGS. 10A and 10B) sunken inward in the radial direction at the four corners on an outer peripheral face. In the recesses 120a, the suspension wires 30A through 30D are arranged, respectively.

The magnet holder 120 includes four magnet covers 120b (see FIGS. 10A and 10B) overhanging inward in the radial direction in end portions (at upper ends) on the plus side in the Z direction at the four corners. The magnet holder 120 includes magnet positioning parts 120c (see FIG. 10B) at the four corners on an inner peripheral face. The magnet positioning parts 120c are provided below the magnet covers 120b (on the minus side in the Z direction), respectively.

The magnet holder 120 includes first upper spring fixing parts 124a and 124b for fixing the upper spring element 13a of the upper elastic support member 13 that are located at the first corner and the fourth corner on a face (top face) on the plus side in the Z direction, respectively.

The first upper spring fixing parts 124a and 124b each have three upper bosses 125a, 125b, and 125c.

On the other hand, the magnet holder 120 includes second upper spring fixing parts 126a and 126b at the second corner and the third corner on the top face, which parts fix an upper spring element 13b of the upper elastic support member 13.

The second upper spring fixing parts 126a and 126b each have one or more (three in the present embodiment) upper bosses 125a, 125b, and 125c.

The magnet holder 120 includes first lower spring fixing parts 121a and 121b (see FIG. 10B) for fixing the lower spring element 14a of the lower elastic support member 14 that are located at the first corner and the fourth corner on a face (bottom face) on the minus side in the Z direction, respectively.

The first lower spring fixing parts 121a and 121b each have two lower bosses 123a and 123b.

The magnet holder 120 includes second lower spring fixing parts 122a and 122b (see FIG. 10B) for fixing the lower spring element 14b of the lower elastic support member 14 that are located at the second corner and the third corner on the face (bottom face) on the minus side in the Z direction, respectively.

The second lower spring fixing parts 122a and 122b each have two lower bosses 123a and 123b.

<Damper>

In each of the recesses 120a of the magnet holder 120, a damper material 15 (see FIGS. 3 through 6) is so placed as to surround the suspension wires 30A through 30D. The damper material 15 suppresses the generation of unnecessary resonance (resonance mode of a high order) so as to contribute toward an ensured stability of operation of the lens driving device 1.

The damper material 15 can readily be applied to the recesses 120a by using a dispenser. Usable as the damper material 15 is an ultraviolet curable silicone gel, for instance.

<Magnet Part>

As illustrated in FIG. 6, the magnet part 127 includes four permanent magnets 128A through 128D. The permanent magnets 128A through 128D are fixed to the magnet positioning parts 120c by adhesion, for instance. In the present embodiment, the permanent magnets 128A through 128D are each approximately isosceles trapezoidal in plan view shape.

The magnet part 127 as above and the AF coil part 111 constitute the AF voice coil motor. The magnet part 127 serves not only as an AF magnet part but the OIS magnet part. In other words, the magnet part 127 also constitutes the OIS voice coil motor to be described later.

<Upper Elastic Support Member>

As illustrated in FIG. 9A, the upper elastic support member 13 is constituted of the upper spring elements 13a and 13b making a pair. The upper spring elements 13a and 13b are each a leaf spring made of titanium copper, nickel copper, stainless steel or the like.

The upper spring element 13a includes a pair of outer fixation parts 131 and 132 to be fixed to the face on the plus side in the Z direction (to be specific, the first upper spring fixing parts 124a and 124b) of the magnet holder 120.

The upper spring element 13a includes an inner fixation part 135 to be fixed to the face on the plus side in the Z direction (to be specific, the upper spring fixing part 110d) of the lens holder 110. The structure of the upper spring element 13b is similar to the structure of the upper spring element 13a. Therefore, parts of the upper spring element 13b that are similar in structure to the parts of the upper spring element 13a are given the same reference signs as the parts of the upper spring element 13a and detailed descriptions on such parts are omitted.

The outer fixation parts 131 and 132 and the inner fixation part 135 are relatively displaceable in the Z direction. In order to allow such relative displacement, the upper spring element 13a in the present embodiment includes a displacement allowing part 137 that allows the relative displacement of the outer fixation parts 131 and 132 and the inner fixation part 135 based on the elastic deformation of the displacement allowing part itself.

The outer fixation parts 131 and 132 include wire fixing parts 133a and 133b, respectively. The wire fixing parts 133a and 133b are arranged on the plus side in the Z direction of the recesses 120a of the magnet holder 120 at the first corner and the fourth corner, respectively.

In the case of the upper spring element 13b, the wire fixing parts 133a and 133b are arranged on the plus side in the Z direction of the recesses 120a of the magnet holder 120 at the second corner and the third corner, respectively.

To the wire fixing parts 133a and 133b, the second end portions (upper ends) of the suspension wires 30A and 30D (suspension wires 30B and 30C in the case of the upper spring element 13b) are fixed with solder.

The outer fixation parts 131 and 132 each have two or more (three in the present embodiment) outer through holes 134a, 134b, and 134c engaged with the upper bosses 125a, 125b, and 125c of the magnet holder 120.

The inner fixation part 135 is arranged inward in the radial direction as compared with the outer fixation parts 131 and 132. The inner fixation part 135 has a pair of inner through holes 136 engaged with the upper bosses 110f of the lens holder 110, which make a pair. The inner fixation part 135 is located by the engagement of the upper bosses 110f with the inner through holes 136.

The displacement allowing part 137 is constituted of a pair of displacement elements 138a and 138b. The displacement elements 138a and 138b are each a wire approximately U-shaped.

The displacement element 138a joins the outer fixation part 131 and the inner fixation part 135. The displacement element 138b joins the outer fixation part 132 and the inner fixation part 135. The structure of the displacement allowing part 137 is not limited to the structure in the present embodiment. The displacement allowing part 137 may have any of various structures joining the outer fixation parts 131 and 132 and the inner fixation part 135 in a manner allowing relative displacement.

The upper spring element 13a as described above is electrically connected to the first terminal 113 of the AF coil part 111 with solder. The upper spring element 13b is connected to the second terminal 114 of the AF coil part 111 with solder. Solder applies to an example of a fixing material.

Specifically, the inner fixation part 135 of the upper spring element 13a and the first terminal 113 of the AF coil part 111 are electrically connected to each other with solder. In addition, the inner fixation part 135 of the upper spring element 13b and the second terminal 114 of the AF coil part 111 are electrically connected to each other with solder.

<Lower Elastic Support Member>

As illustrated in FIG. 9B, the lower elastic support member 14 is constituted of the lower spring elements 14a and 14b making a pair. The lower spring elements 14a and 14b are each a leaf spring made of titanium copper, nickel copper, stainless steel or the like.

The lower spring element 14a includes a pair of outer fixation parts 141 and 142 to be fixed to the face on the minus side in the Z direction (to be specific, the first lower spring fixing parts 121a and 121b) of the magnet holder 120.

The lower spring element 14a includes the inner fixation part 144 to be fixed to the face on the minus side in the Z direction (to be specific, the lower spring fixing part 110k) of the lens holder 110. In the lower spring element 14b, the inner fixation part 144 is fixed to the face on the minus side in the Z direction (to be specific, the lower spring fixing part 110m) of the lens holder 110. The structure of the lower spring element 14b is similar to the structure of the lower spring element 14a. Therefore, parts of the lower spring element 14b that are similar in structure to the parts of the lower spring element 14a are given the same reference signs as the parts of the lower spring element 14a and detailed descriptions on such parts are omitted.

The outer fixation parts 141 and 142 and the inner fixation part 144 are relatively displaceable in the Z direction. In order to allow such relative displacement, the lower spring element 14a in the present embodiment includes a displacement allowing part 146 that allows the relative displacement of the outer fixation parts 141 and 142 and the inner fixation part 144 based on the elastic deformation of the displacement allowing part itself.

Neither of the lower spring elements 14a and 14b is connected to the suspension wires 30A through 30D.

The outer fixation parts 141 and 142 each have two or more (two in the present embodiment) outer through holes 143a and 143b engaged with the lower bosses 123a and 123b of the magnet holder 120.

The inner fixation part 144 is arranged inward in the radial direction as compared with the outer fixation parts 141 and 142. The inner fixation part 144 has a pair of inner through holes 145a and 145b engaged with the lower bosses 110n of the lens holder 110, which make a pair. The inner fixation part 144 is located by the engagement of the lower bosses 110n making a pair with the inner through holes 145a and 145b.

The displacement allowing part 146 is constituted of a pair of displacement elements 147a and 147b. The displacement elements 147a and 147b making a pair are each a wire approximately U-shaped.

The displacement element 147a joins the outer fixation part 141 and the inner fixation part 144. The displacement element 147b joins the outer fixation part 142 and the inner fixation part 144. The structure of the displacement allowing part 146 is not limited to the structure in the present embodiment. The displacement allowing part 146 may have any of various structures joining the outer fixation parts 141 and 142 and the inner fixation part 144 in a manner allowing relative displacement.

<OIS Immovable Part>

As illustrated in FIGS. 5 and 6, the OIS immovable part 20 includes a coil substrate 21, the base 23, and the lead 24.

<Coil Substrate>

As illustrated in FIG. 5, the coil substrate 21 is a substrate assuming an approximately square contour in plan view shape. The coil substrate 21 is arranged on a top face of the base 23.

The coil substrate 21 has a circular opening 21a in the center. The coil substrate 21 includes an OIS coil part 22 occupying the four corners.

The OIS coil part 22 includes a first OIS coil 22A provided at the first corner of the coil substrate 21, a second OIS coil 22B provided at the second corner of the coil substrate 21, a third OIS coil 22C provided at the third corner of the coil substrate 21, and a fourth OIS coil 22D provided at the fourth corner of the coil substrate 21.

The coils 22A through 22D constituting the OIS coil part 22 are each a printed coil formed on the coil substrate 21 according to a pattern. The coils constituting the OIS coil part 22 may each be an air core coil. The power feed to the OIS coil part 22 is controlled by a controller IC (not illustrated).

The first OIS coil 22A is arranged lower (on the minus side in the Z direction) than the permanent magnet 128A of the magnet part 127. The first OIS coil 22A and the permanent magnet 128A are opposite to each other in the Z direction.

The second OIS coil 22B is arranged lower (on the minus side in the Z direction) than the permanent magnet 128B of the magnet part 127. The second OIS coil 22B and the permanent magnet 128B are opposite to each other in the Z direction.

The third OIS coil 22C is arranged lower (on the minus side in the Z direction) than the permanent magnet 128C of the magnet part 127. The third OIS coil 22C and the permanent magnet 128C are opposite to each other in the Z direction.

The fourth OIS coil 22D is arranged lower (on the minus side in the Z direction) than the permanent magnet 128D of the magnet part 127. The fourth OIS coil 22D and the permanent magnet 128D are opposite to each other in the Z direction.

The size and arrangement of the OIS coils 22A through 22D and the permanent magnets 128A through 128D are set so that magnetic fields radiated from bottom faces of the permanent magnets 128A through 128D may traverse the OIS coils 22A through 22D in the Z direction, respectively. The OIS coil part 22 as above and the magnet part 127 constitute the OIS voice coil motor.

<Base>

The base 23 is a support member supporting the coil substrate 21. The base 23 is made of a nonconductive material such as a synthetic resin, a liquid crystal polymer (LCP: Liquid Crystal Polymer), for instance, and is a plate-like member that is approximately square in plan view shape.

The base 23 has a circular opening 23a in the center. The base 23 has lead notches 231 sunken inward in the radial direction at the four corners. The base 23 has lead positioning spaces 232 in portions surrounded by the lead notches 231, respectively. The lead positioning spaces 232 are each open on both sides in the Z direction and outside in the radial direction.

The base 23 is fixed to the cover 7 with an adhesive (e.g., an epoxy resin).

In the camera module A as assembled, the imaging element (not illustrated) held by a sensor base (not illustrated) is arranged on the minus side in the Z direction of the base 23. The sensor base is fixed to a top face (face on the plus side in the Z direction) of the sensor substrate (not illustrated).

<Lead>

The lead 24 is a leaf spring made of a conductive material such as phosphor bronze, nickel copper or stainless steel. The lead 24 is embedded in the base 23. The lead 24 includes the wire connectors 241A through 241D, which are emerged from the four corners of the base 23, respectively.

The wire connector 241A is connected to the first end portion (lower end portion) of the suspension wire 30A. The wire connector 241B is connected to the first end portion (lower end portion) of the suspension wire 30B. The wire connector 241C is connected to the first end portion (lower end portion) of the suspension wire 30C. The wire connector 241D is connected to the first end portion (lower end portion) of the suspension wire 30D.

The lead 24 includes two or more (eight in the present embodiment) terminals 25a through 25h. The terminals 25a through 25d are emerged from a first end portion (end portion on the plus side in the Y direction) of the base 23. The terminals 25e through 25h are emerged from a second end portion (end portion on the minus side in the Y direction) of the base 23 that is opposite from the first end portion.

Some terminals among the terminals 25a through 25h are power feed terminals for feeding electric power to the AF drive unit. Some terminals among the terminals 25a through 25h are power feed terminals for feeding electric power to the OIS drive unit.

<About Operation of Lens Driving Device>

When shake correction is performed in the lens driving device 1 of the present embodiment, which has the configuration as described above, the OIS coil part 22 is (that is to say, the first OIS coil 22A through the fourth OIS coil 22D are) electrified. If the OIS coil part 22 is electrified, the Lorentz force is generated in the OIS coil part 22 by the interaction between a magnetic field of the magnet part 127 and an electric current passing through the OIS coil part 22 (Fleming's left hand rule).

The direction of the Lorentz force is a direction parallel to a plane orthogonal to the optical axis. Since the OIS coil part 22 is fixed, a reaction force acts on the permanent magnets 128A through 128D constituting the magnet part 127, based on the Lorentz force as above. The reaction force serves as a driving force for the OIS voice coil motor, so that the OIS movable part 10 including the magnet part 127 is swayed in a plane orthogonal to the optical axis and shake correction is performed.

When autofocus is performed in the lens driving device 1, the AF coil part 111 is electrified. If the AF coil part 111 is electrified, the Lorentz force is generated in the AF coil part 111 by the interaction between a magnetic field of the magnet part 127 and an electric current passing through the AF coil part 111.

The direction of the Lorentz force is a direction that is orthogonal not only to the direction of the magnetic field but the direction of the electric current passing through the AF coil part 111 (namely, the Z direction). Since the magnet part 127 is fixed, a reaction force acts on the AF coil part 111.

The reaction force serves as a driving force for the AF voice coil motor, so that the AF movable part 11 including the AF coil part 111 is moved in the Z direction (optical axis direction) and focusing is performed.

### About Functions and Effects of Present Embodiment

According to the lens driving device 1 of the present embodiment, which has the configuration as described above, attachment of the AF coil part 111 to the lens holder 110 is readily carried out. The reason is explained below.

In the lens driving device 1 of the present embodiment, the AF coil part 111 includes the first terminal 113 and the second terminal 114, both provided upright with respect to the winding 112. The winding 112 of the AF coil part 111 is attached to the lens holder 110 from the minus side in the Z direction and, in such state, the first terminal 113 is positioned in the inner notch 110i (also referred to as the first terminal positioning part) of the lens holder 110 and the second terminal 114 is positioned in the inner notch 110j (also referred to as the second terminal positioning part) of the lens holder 110. The first terminal 113 and the second terminal 114 are then fixed to the upper elastic support member 13 with solder. Thus, the lens driving device 1 of the present embodiment does not require the tying operation, which is required by the lens driving device stated in the above-mentioned Patent Literature 1. As a result, the efficiency of attachment of the AF coil part 111 to the lens holder 110 is improved.

In the embodiment as described above, the camera-loaded apparatus, which is loaded with the camera module A, is exemplified by the smartphone M as a portable terminal with camera, while the present invention is applicable to a camera-loaded apparatus as information equipment or transportation equipment. The camera-loaded apparatus as information equipment refers to information equipment including a camera module and a controller that processes image information obtained by the camera module, and examples of such information equipment include a portable telephone with camera, a notebook sized personal computer, a tablet type terminal, a handheld game console, a webcam, and an onboard apparatus with camera (e.g., a back monitoring apparatus or a drive recorder apparatus). The camera-loaded apparatus as transportation equipment refers to transportation equipment including a camera module and a controller that processes images obtained by the camera module, and examples of such transportation equipment include an automobile.

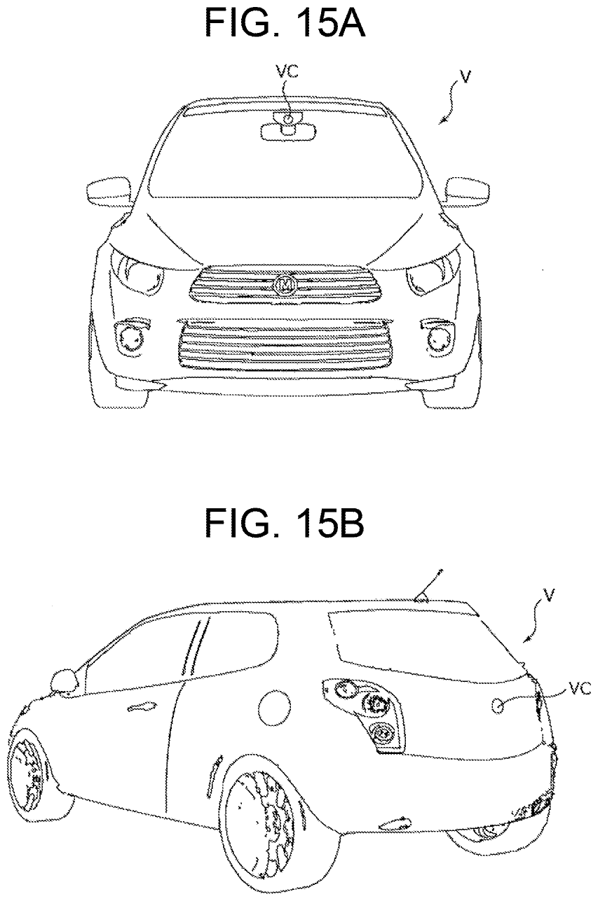

FIGS. 15A and 15B are diagrams illustrating an automobile V as a camera-loaded apparatus that is loaded with an onboard camera module VC (Vehicle Camera). FIG. 15A is a front view of the automobile V and FIG. 15B is a rear perspective view of the automobile V. The automobile V is loaded with the camera module A described in the embodiment as the onboard camera module VC. As illustrated in FIGS. 15A and 15B, the onboard camera module VC may be attached to a windshield and directed ahead or attached to a rear gate and directed behind. The onboard camera module VC is used for a back monitor, for a drive recorder, for collision avoidance control, for self-driving control, and for other purposes.

The embodiment as disclosed herein should be considered to be a no limitative example at all points. The scope of the present invention is defined not by the above description but the Claims, and it is intended that any modification equivalent in meaning and scope to the Claims falls within the scope of the present invention.

The disclosed contents of the specification, the drawings, and the abstract contained in Japanese Patent Application No. 2019-7607 filed on Jan. 21, 2019 are incorporated herein by reference in their entirety.

### INDUSTRIAL APPLICABILITY

The lens driving device, the camera module, and the camera-loaded apparatus according to the present invention are applicable to a thin apparatus with camera, such as a smartphone, a portable telephone, a digital camera, a notebook sized personal computer, a tablet type terminal, a handheld game console, and an onboard camera.

### DESCRIPTION OF REFERENCE NUMERALS

1 lens driving device
10 OIS movable part
11 AF movable part
110 lens holder
110a lens container
110b flange
110c coil positioning part
110d, 110e upper spring fixing part
110f upper boss
110g, 110h outer notch
110i, 110j inner notch
110k, 110m lower spring fixing part
110n lower boss
111, 111A AF coil part
112 winding
113, 113A first terminal
114, 114A second terminal
115 side portion
116 vertex portion
117 first end portion
118 second end portion
12 AF immovable part
120 magnet holder
120a recess
120b magnet cover
120c magnet positioning part
121a, 121b first lower spring fixing part
122a, 122b second lower spring fixing part
123a, 123b lower boss
124a, 124b first upper spring fixing part
125a, 125b, 125c upper boss
126a, 126b second upper spring fixing part
127 magnet part
128A, 128B, 128C, 128D permanent magnet
13 upper elastic support member (upper leaf spring)
13a, 13b upper spring element
131, 132 outer fixation part
133a, 133b wire fixing part
134a, 134b, 134c outer through hole
135 inner fixation part
136 inner through hole
137 displacement allowing part
138a, 138b displacement element
14 lower elastic support member (lower leaf spring)
14a, 14b lower spring element
141, 142 outer fixation part
143a, 143b outer through hole
144 inner fixation part
145a, 145b inner through hole
146 displacement allowing part
147a, 147b displacement element
15 damper material
20 OIS immovable part
21 coil substrate
21a opening
22 OIS coil part
22A first OIS coil
22B second OIS coil
22C third OIS coil
22D fourth OIS coil
23 base
23a opening
231 lead notch
232 lead positioning space
24 lead
241A, 241B, 241C, 241D wire connector
25a, 25b, 25c, 25d, 25e, 25f, 25g, 25h terminal
30 suspension wire
30A, 30B, 30C, 30D suspension wire
6 lens section
61 lens barrel
62 lens
7 cover
71 opening
8 jig
81 base
81a first end face
82 winding part
83 first protrusion
84 second protrusion
85 step portion
A camera module
M smartphone (camera-loaded apparatus)

1. A lens driving device comprising:
a first holder to hold a lens section;
a second holder provided around a lens holder;
a support member that elastically supports the first holder with respect to the second holder; and
an actuator that includes a coil with a winding so arranged on the first holder as to surround the lens section, and a magnet so provided on the second holder as to face the coil, and is to move the first holder with respect to the second holder in a direction of an optical axis,
wherein an end portion of the winding is provided with an upright terminal that is set upright with respect to a winding plane of the winding and electrically connected to the support member with a fixing material, and
wherein the first holder includes a terminal positioning part that internally accepts the upright terminal.

2. The lens driving device according to claim 1, wherein the upright terminal extends from the winding in a direction along a winding axis of the winding.

3. The lens driving device according to claim 2, wherein the winding is in a polygonal shape and has at least three side portions and at least three vertex portions joining the side portions adjacent to each other, and
wherein the upright terminal extends from the side portions in the direction along the winding axis.

4. The lens driving device according to claim 2, wherein the winding is in a polygonal shape and has at least three side portions and at least three vertex portions joining the side portions adjacent to each other, and
wherein the upright terminal extends from the vertex portions in the direction along the winding axis.

5. The lens driving device according to claim 1, wherein the upright terminal extends in a direction of attachment of the coil to the first holder.

6. The lens driving device according to claim 1, wherein the upright terminal is helically wound.

7. The lens driving device according to claim 6, wherein the upright terminal is helically wound and assumes a conical contour.

8. The lens driving device according to claim 6, wherein the upright terminal has an outer diameter two or more times as large as an outer diameter of a wire constituting the winding.

9. The lens driving device according to claim 1, wherein the support member constitutes a path for feeding electric power to the coil.

10. The lens driving device according to claim 1, wherein a tip end of the upright terminal is so arranged as to protrude from the terminal positioning part and is connected to the support member.

11. A camera module comprising:
the lens driving device according to claim 1;
a lens section to be fitted to the first holder; and
an imaging unit to capture a subject image formed by the lens section.

12. A camera-loaded apparatus as information equipment or transportation equipment, the camera-loaded apparatus comprising:
the camera module according to claim 11; and
an image processor to process image information obtained by the camera module.
